(19) United States
(12) Patent Application Publication
(10) Pub. No.: US 2025/0351167 A1
(43) Pub. Date: Nov. 13, 2025

(54) NON-PRIMARY CHANNEL ACCESS INDICATION TRANSMISSION METHOD AND APPARATUS THEREOF

(71) Applicant: MEDIATEK INC., Hsinchu City (TW)

(72) Inventors: Hao-Hua KANG, Hsinchu City (TW); Chien-Fang HSU, Hsinchu City (TW); Chih-Chun KUO, Hsinchu City (TW)

(21) Appl. No.: 19/199,498

(22) Filed: May 6, 2025

Related U.S. Application Data
(60) Provisional application No. 63/645,213, filed on May 10, 2024.

(51) Int. Cl. H04W 74/08; H04W 74/00; H04W 84/12

(52) U.S. Cl. CPC H04W 74/08; H04W 74/002; H04W 84/12

(57) ABSTRACT

A non-primary channel access (NPCA) indication transmission is provided. The NPCA indication transmission method may include the following steps. A first multi-link device (MLD) may establish a plurality of links with a second MLD. In an event that an overlapping basic service set (OBSS) interference is detected by the first MLD in a primary channel of a first link of the plurality of links, the first MLD may transmit an NPCA indication associated with the first link to the second MLD in a second link of the plurality of links. The first MLD may perform data transmission with the second MLD in a non-primary channel of the first link according to the NPCA indication.

### CROSS REFERENCE TO RELATED APPLICATIONS

This application claims the benefit of U.S. Provisional Application No. 63/645,213 filed on May 10, 2024, the entirety of which is incorporated by reference herein.

### BACKGROUND OF THE INVENTION

### Field of the Invention

The invention generally relates to wireless communications technology, and more particularly, it relates to non-primary channel access (NPCA) indication.

### Description of the Related Art

Unless otherwise indicated herein, the approaches described in this section are not prior art to the claims listed below and are not admitted as prior art by inclusion in this section.

As demand for ubiquitous computing and networking has grown, various wireless technologies have been developed, including Wireless-Fidelity (Wi-Fi) which is a Wireless Local Area Network (WLAN) technology that allows mobile devices (such as smartphones, smart pads, laptop computers, portable multimedia players, embedded apparatuses, and the like) to obtain wireless services in a frequency band of 2.4 GHz, 5 GHz, 6 GHz or 60 GHz.

The Institute of Electrical and Electronics Engineers (IEEE) has developed and commercialized various technological standards since the initial WLAN technology is supported using frequencies of 2.4 GHz. For example, IEEE 802.11ac supports Multi-User (MU) transmission using spatial degrees of freedom via a MU-Multiple-Input-Multiple-Output (MU-MIMO) scheme in a downlink (DL) direction from an Access Point (AP) to Stations (STAs). To improve performance and meet user's demand for high-capacity and high-rate services, the IEEE 802.11ax has been proposed that uses both Orthogonal Frequency Division Multiple Access (OFDMA) and MU-MIMO in both DL and uplink (UL) directions. In addition to supporting frequency and spatial multiplexing from an AP to multiple STAs, transmissions from multiple STAs to the AP are also supported in IEEE 802.11ax.

In a Wi-Fi multi-link operation (MLO), there exists several links between two Wi-Fi multi-link devices (MLDs), including one access point (AP) MLD and one non-AP MLD (e.g., an STA), that occupy different radio-frequency (RF) bands. In the conventional technologies, the AP MLD and the STA MLD may be operated in the enhanced multi-link single radio (EMLSR) mode of the MLO on a specified set of the enabled links (e.g., EMLSR links) between the AP MLD and the STA MLD. In addition, in the conventional technologies, when the overlapping basic service set (OBSS) interference is detected by the AP MLD and the STA MLD in the primary channel, the AP MLD and the STA MLD may perform non-primary channel access (NPCA) to switch to the non-primary channel which is negotiated by the AP MLD and the STA MLD in advance. However, when the hidden node scenario is occurred in a link (or EMLSR link) (e.g., the AP MLD detect the OBSS interference in the primary channel of the link, but the STA MLD does not detect the OBSS interference in the primary channel of the link), the STA MLD (or AP MLD) may not perform the NPCA to switch to the non-primary channel. Therefore, the data transmission between the AP MLD and the STA MLD in the link may fail.

Therefore, how to avoid the hidden node problem for NPCA is a topic that is worthy of discussion.

### BRIEF SUMMARY OF THE INVENTION

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to non-primary channel access (NPCA) indication transmission method with respect to an access point (AP) and a user equipment (UE) in a multi-link operation (MLO) communication. It is believed that the issue described above can be avoided or otherwise alleviated by implementing one or more of the proposed schemes described herein.

An embodiment of the invention provides an NPCA indication transmission method. The NPCA indication transmission method may include the following steps. The NPCA indication transmission method may comprise that a first multi-link device (MLD) establishes a plurality of links with a second MLD. The NPCA indication transmission method may also comprise that in an event that an overlapping basic service set (OBSS) interference is detected by the first MLD in a primary channel of a first link of the plurality of links, the first MLD transmits an NPCA indication associated with the first link to the second MLD in a second link of the plurality of links. The NPCA indication transmission method may further comprise that the first MLD performs data transmission with the second MLD in a non-primary channel of the first link according to the NPCA indication.

In some embodiments, the NPCA indication may comprise the index of the non-primary channel, the switch back time, the number of spatial streams (NSS), the bandwidth (BW), the modulation and coding scheme (MCS), the transmission (TX) power, or a combination thereof.

In some embodiments, the switch back time may be associated with a countdown timer for the remaining duration of backing to the primary channel, or associated with a timestamp of the end time of the OBSS interference.

In some embodiments, the NPCA indication may be carried on a frame exchange sequence (FES), or on a FES with the second MLD.

In some embodiments, the NPCA indication may be transmitted through a broadcast, a multicast, a control frame, a management frame, or a broadcast management frame.

In some embodiments, the broadcast management frame may comprise a beacon frame.

In some embodiments, the first MLD is an access point (AP) MLD and the second MLD is a non-AP MLD, or the first MLD is a non-AP MLD and the second MLD is an AP MLD.

An embodiment of the invention provides an apparatus. The apparatus may comprise a transceiver and a processor. The transceiver may, during operation, wirelessly communicate with a transmitting apparatus through a multi-link device (MLD). The processor may be communicatively coupled to the transceiver such that, during operation, the processor performs following operations. The processor may establish a plurality of links with the MLD. In an event that an overlapping basic service set (OBSS) interference is detected by apparatus in a primary channel of a first link of the plurality of links, the processor may transmit, via the transceiver, an NPCA indication associated with the first link to the MLD in a second link of the plurality of links. The processor may perform data transmission with the MLD in a non-primary channel of the first link according to the NPCA indication.

An embodiment of the invention provides an NPCA indication transmission method. The NPCA indication transmission method may include the following steps. The NPCA indication transmission method may comprise that a second multi-link device (MLD) establish a plurality of links with a first MLD. The NPCA indication transmission method may also comprise that the second MLD receives an NPCA indication associated with a first link of the plurality of links from the first MLD in a second link of the plurality of links. The NPCA indication transmission method may further comprise that the second MLD performs data transmission with the first MLD in a non-primary channel of the first link according to the NPCA indication.

Other aspects and features of the invention will become apparent to those with ordinary skill in the art upon review of the following descriptions of specific embodiments of the NPCA indication transmission methods and apparatus.

### BRIEF DESCRIPTION OF THE DRAWINGS

The invention will become more fully understood by referring to the following detailed description with reference to the accompanying drawings, wherein:

FIG. 1 is a block diagram of a wireless communication system 100 according to an embodiment of the application.

FIG. 2 is a block diagram illustrating a communication apparatus according to an embodiment of the application.

FIG. 3 is a block diagram illustrating a network node according to an embodiment of the application.

FIG. 4 is a schematic diagram illustrating a NPCA indication transmission according to an embodiment of the application.

FIG. 5 is a schematic diagram illustrating a NPCA indication transmission according to another embodiment of the application.

FIG. 6 is a flow chart illustrating an NPCA indication transmission method according to an embodiment of the invention.

FIG. 7 is a flow chart illustrating an NPCA indication according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

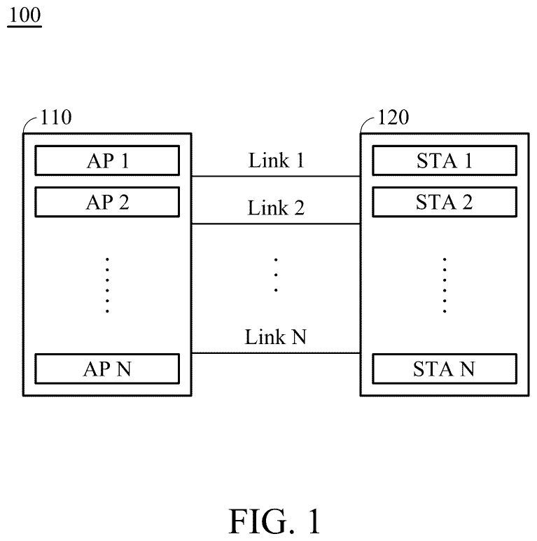

FIG. 1 is a block diagram of a wireless communication system 100 according to an embodiment of the application. As shown in FIG. 1, the wireless communication system 100 may include a network node (take an access point, AP, as an example) 110 and a communication apparatus 120. The AP 110 and the communication apparatus 120 may be the multi-link devices (MLDs), i.e., the AP 110 may be an AP MLD and the communication apparatus 120 may be a non-AP STA MLD. That is, the AP 110 may perform multi-link operation (MLO) with the communication apparatus 120 through multiple wireless links Link 1, Link 2 . . . Link N. Specifically, as shown in FIG. 1, the AP 110 may comprise a plurality of AP modules AP 1, AP 2, . . . , AP N, and the communication apparatus 120 may comprise a plurality of station (STA) modules (or non-AP STA modules) STA 1, STA 2, . . . , STA N. Each AP module and its corresponding STA module may correspond to a wireless link, e.g., AP 1 and STA 1 may correspond to Link 1. Each wireless link may correspond to a band, e.g., 2.4 GH, 5 GHz, or 6 GHz, but the invention should not be limited thereto. It should be noted that, in order to clarify the concept of the invention, FIG. 1 presents a simplified block diagram in which only the elements relevant to the invention are shown. However, the invention should not be limited to what is shown in FIG. 1.

According to the embodiments of the invention, the MLO operation for the STA modules may comprise the simultaneous transmit and receive (STR) mode and enhanced multi-link single radio (EMLSR) mode. In addition, according to the embodiments of the invention, the AP 110 and the communication apparatus 120 may support non-primary channel access (NPCA). That is, the AP 110 and the communication apparatus 120 may negotiate one or more non-primary channels for the NPCA in each link.

The AP 110 may be an entity compatible with the Institute of Electrical and Electronics Engineers (IEEE) 802.11 standards to provide and manage the access to the wireless medium for the communication apparatus 120.

According to an embodiment of the invention, the AP 110 may be an Extremely High Throughput (EHT) AP which is compatible with the IEEE 802.11be standards. In another embodiment of the invention, the AP 110 may be an AP which is compatible with any IEEE 802.11 standards later than 802.11be.

According to the embodiments of the invention, the communication apparatus 120 may be user equipment (UE), a non-AP station (STA), a mobile phone (e.g., feature phone or smartphone), a panel Personal Computer (PC), a laptop computer, or any computing device, as long as it is compatible with the same IEEE 802.11 standards as the AP 110. The communication apparatus 120 may associate and communicate with the AP 110 to send or receive data in an uplink (UL) or downlink (DL) Multi-User-Physical layer Protocol Data Unit (MU-PPDU). The MU-PPDU may be a resource-unit Orthogonal Frequency Division Multiple Access (RU-OFDMA), a MU-Multiple Input-Multiple-Output (MU-MIMO) PPDU, or an aggregated PPDU.

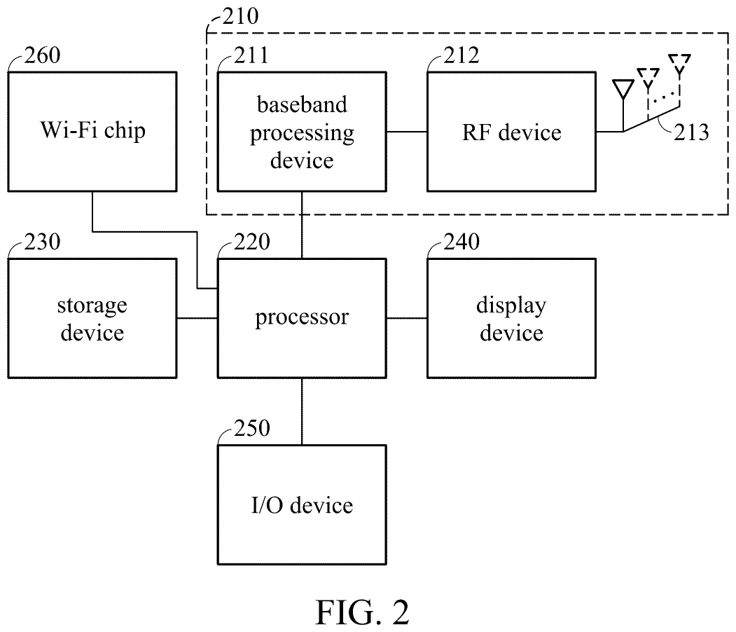

FIG. 2 is a block diagram illustrating a communication apparatus 200 according to an embodiment of the application. The communication apparatus 200 can be applied to the communication apparatus 120. As shown in FIG. 2, the communication apparatus 200 may comprise a wireless transceiver 210, a processor 220, a storage device 230, a display device 240, an Input/Output (I/O) device 250 and a Wi-Fi chip 260.

The wireless transceiver 210 may be configured to perform wireless transmission and reception to and from the communication apparatus 120.

Specifically, the wireless transceiver 210 may include a baseband processing device 211, a Radio Frequency (RF) device 212, and antenna 213, wherein the antenna 213 may include an antenna array for UL/DL MIMO.

The baseband processing device 211 may be configured to perform baseband signal processing, such as Analog-to-Digital Conversion (ADC)/Digital-to-Analog Conversion (DAC), gain adjusting, modulation/demodulation, encoding/decoding, and so on. The baseband processing device 211 may contain multiple hardware components, such as a baseband processor, to perform the baseband signal processing.

The RF device 212 may receive RF wireless signals via the antenna 213, convert the received RF wireless signals to baseband signals, which are processed by the baseband processing device 211, or receive baseband signals from the baseband processing device 211 and convert the received baseband signals to RF wireless signals, which are later transmitted via the antenna 213. The RF device 212 may comprise a plurality of hardware elements to perform radio frequency conversion. For example, the RF device 212 may comprise a power amplifier, a mixer, analog-to-digital converter (ADC)/digital-to-analog converter (DAC), etc.

According to an embodiment of the invention, the RF device 212 and the baseband processing device 211 may collectively be regarded as a radio module capable of communicating with a wireless network to provide wireless communications services in compliance with a predetermined Radio Access Technology (RAT). Note that, in some embodiments of the invention, the communication apparatus 200 may be extended further to comprise more than one antenna and/or more than one radio module, and the invention should not be limited to what is shown in FIG. 2

The processor 220 may be a general-purpose processor, a Central Processing Unit (CPU), a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 210 for wireless communications with the AP 110, storing and retrieving data (e.g., program code) to and from the storage device 230, sending a series of frame data (e.g. representing text messages, graphics, images, etc.) to the display device 240, and receiving user inputs or outputting signals via the I/O device 250.

In particular, the processor 220 coordinates the aforementioned operations of the wireless transceiver 210, the storage device 230, the display device 240, the I/O device 250, and the Wi-Fi chip 260 for performing the method of the present application.

As will be appreciated by persons skilled in the art, the circuits of the processor 220 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 230 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application.

The display device 240 may be a Liquid-Crystal Display (LCD), a Light-Emitting Diode (LED) display, an Organic LED (OLED) display, or an Electronic Paper Display (EPD), etc., for providing a display function. Alternatively, the display device 240 may further include one or more touch sensors for sensing touches, contacts, or approximations of objects, such as fingers or styluses.

The I/O device 250 may include one or more buttons, a keyboard, a mouse, a touch pad, a video camera, a microphone, and/or a speaker, etc., to serve as the Man-Machine Interface (MMI) for interaction with users.

According to an embodiment of the invention, the Wi-Fi chip 260 may be configured to perform the operations of Wi-Fi communications. In another embodiment of the invention, the wireless transceiver 210 may be also combined with the Wi-Fi chip 260 to form a Wi-Fi chip.

It should be understood that the components described in the embodiment of FIG. 2 are for illustrative purposes only and are not intended to limit the scope of the application. For example, a communication apparatus may include more components, such as another wireless transceiver for providing telecommunication services, a Global Positioning System (GPS) device for use of some location-based services or applications, and/or a battery for powering the other components of the communication apparatus, etc. Alternatively, a communication apparatus may include fewer components. For example, the communication apparatus 200 may not include the display device 240 and/or the I/O device 250.

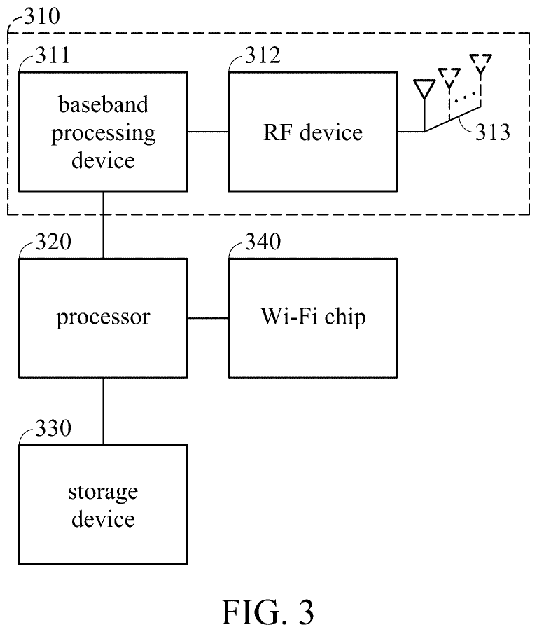

FIG. 3 is a block diagram illustrating a network apparatus 300 according to an embodiment of the application. The network apparatus 300 can be applied to the AP 110. As shown in FIG. 3, the network apparatus 300 may comprise a wireless transceiver 310, a processor 320, a storage device 330, and a Wi-Fi chip 340.

The wireless transceiver 310 is configured to perform wireless transmission and reception to and from one or more communication apparatuses (e.g., the communication apparatus 120).

Specifically, the wireless transceiver 310 may include a baseband processing device 311, an RF device 312, and antenna 313, wherein the antenna 313 may include an antenna array for UL/DL MU-MIMO.

The baseband processing device 311 is configured to perform baseband signal processing, such as ADC/DAC, gain adjusting, modulation/demodulation, encoding/decoding, and so on. The baseband processing device 311 may contain multiple hardware components, such as a baseband processor, to perform the baseband signal processing.

The RF device 312 may receive RF wireless signals via the antenna 313, convert the received RF wireless signals to baseband signals, which are processed by the baseband processing device 311, or receive baseband signals from the baseband processing device 311 and convert the received baseband signals to RF wireless signals, which are later transmitted via the antenna 313. The RF device 312 may comprise a plurality of hardware elements to perform radio frequency conversion. For example, the RF device 312 may comprise a power amplifier, a mixer, analog-to-digital converter (ADC)/digital-to-analog converter (DAC), etc.

The processor 320 may be a general-purpose processor, an MCU, an application processor, a DSP, a GPH/HPU/NPU, or the like, which includes various circuits for providing the functions of data processing and computing, controlling the wireless transceiver 310 for wireless communications with the communication apparatus 120, and storing and retrieving data (e.g., program code) to and from the storage device 330.

In particular, the processor 320 coordinates the aforementioned operations of the wireless transceiver 310 and the storage device 330 for performing the method of the present application.

In another embodiment, the processor 320 may be incorporated into the baseband processing device 311, to serve as a baseband processor.

As will be appreciated by persons skilled in the art, the circuits of the processor 320 may include transistors that are configured in such a way as to control the operation of the circuits in accordance with the functions and operations described herein. As will be further appreciated, the specific structure or interconnections of the transistors may be determined by a compiler, such as an RTL compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 330 may be a non-transitory machine-readable storage medium, including a memory, such as a FLASH memory or a NVRAM, or a magnetic storage device, such as a hard disk or a magnetic tape, or an optical disc, or any combination thereof for storing data, instructions, and/or program code of applications, communication protocols, and/or the method of the present application.

According to an embodiment of the invention, the Wi-Fi chip 340 may be configured to perform the operations of Wi-Fi communications. In another embodiment of the invention, the wireless transceiver 310 may be also combined with the Wi-Fi chip 340 to form a Wi-Fi chip.

It should be understood that the components described in the embodiment of FIG. 3 are for illustrative purposes only and are not intended to limit the scope of the application. For example, an AP may include more components, such as a display device for providing a display function, and/or an I/O device for providing an MMI for interaction with users.

According to an embodiment of the invention, a first MLD (e.g., the AP 110 or the communication apparatus 120) may establish a plurality of links with a second MLD (e.g., the communication apparatus 120 or the AP 110) to perform MLO. In the event that the first MLD detects an overlapping basic service set (OBSS) interference in a primary channel of a first link of the links, the first MLD may transmit an NPCA indication associated with the first link to the second MLD in a second link of the established links. That is, the first MLD can provide its NPCA status in the first link to the second MLD. Then, when the data transmission between the first MLD and the second MLD in the first link is performed, the first MLD and the second MLD may perform data transmission in a non-primary channel of the first link according to the NPCA indication. Therefore, in the embodiments of the invention, even if the second MLD does not detect the OBSS interference in the first link, the second MLD also can switch to the non-primary channel (or secondary channel) of the first link according to the NPCA indication from the first MLD.

According to an embodiment of the invention, the NPCA indication comprises the index of the non-primary channel, the switch back time, the number of spatial streams (NSS), the bandwidth (BW), the modulation and coding scheme (MCS), the transmission (TX) power, or a combination thereof. In one example, according to the NPCA indication, the second MLD may know the NPCA status of the first MLD in the first link, i.e., the second MLD can know the NPCA is enabled in which link according to the NPCA indication. In another example, in the NPCA indication, the second MLD may also know that it should switch to which non-primary channel (or secondary channel) of the first link when the NPCA is enabled in the first link. In addition, in another example, according to the NPAC indication, the second MLD may further know when needing to switch back to the primary channel of the first link. In an embodiment, the switch back time in the NPCA indication may be associated with a countdown timer for the remaining duration of backing to the primary channel. Therefore, when the countdown timer is terminated, the second MLD may switch to the primary channel in the first link according to the NPCA indication. In another embodiment, the switch back time in the NPCA indication may be associated with a timestamp of the end time of the OBSS interference. That is, the second MLD can know when the transmission of OBSS in the first link is terminated (e.g., know the end of the OBSS physical layer protocol data unit (PDDU) or the OBSS transmission opportunity (TXOP)). Therefore, the second MLD can switch to the primary channel in the first link after the end time of the OBSS interference according to the NPCA.

According to an embodiment of the invention, the NPCA indication may be carried on a frame exchange sequence (FES), or on a FES with the second MLD. For example, the NPCA indication may be carried in a data frame and/or a contention-free end (CFE) frame, but the invention should not be limited thereto. In the embodiment, the first MLD may transmit the NPCA indication associated with the first link through the FES in the second link.

According to another embodiment of the invention, the NPCA indication may be transmitted through a broadcast, a multicast, a control frame, a management frame, or a broadcast management frame. For example, the broadcast management frame may comprise a beacon frame. In the embodiment, the first MLD may transmit the NPCA indication associated with the first link through the broadcast, the multicast, the control frame, the management frame, or the broadcast management frame in the second link.

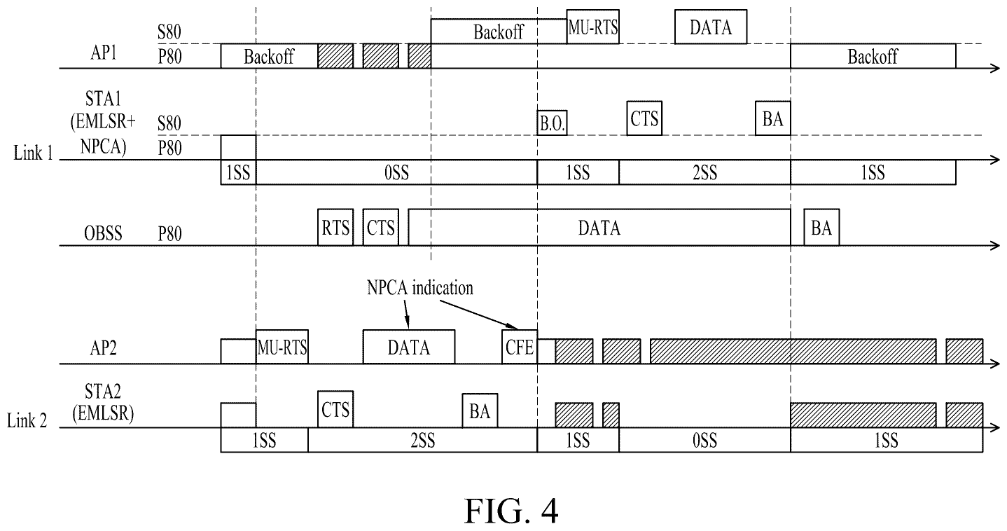

FIG. 4 is a schematic diagram illustrating a NPCA indication transmission according to an embodiment of the application. The NPCA indication transmission can be applied to the AP 110 and the communication apparatus 120 in the wireless communication system 100. In the embodiment, it is assumed that the first MLD is an AP MLD, and the second MLD is a non-AP MLD (e.g., an STA), but the invention should not be limited thereto. In addition, in the embodiment, the STA 1 and the STA 2 of the second MLD are operated in the EMLSR mode of the MLO. As shown in FIG. 4, the AP 1 of the first MLD may detect the OBSS interference in the primary channel (e.g., P80) of the first link (e.g., Link 1) when the AP 2 of the first MLD and the STA 2 of the second MLD uses two spatial stream (SS) (or two antennas) to perform data transmission in the second link (e.g., Link 2). The first MLD may transmit the NPCA indication associated with the first link to the second MLD through the FES (e.g., through data frame and/or CFE frame) between the first MLD and the second MLD in the second link, i.e., the NPCA indication can be carried in the FES between the first MLD and the second MLD. Therefore, when the AP 1 of the first MLD and the STA 1 of the second MLD need to perform the data transmission in the first link, both of the AP 1 and the STA 1 can switch to the non-primary channel (e.g., S80) of the first link according to the NPCA indication to perform the data transmission. That is, even if the second MLD does not detect the OBSS interference (e.g., the second MLD only detects the clear channel assessment (CCA) from the OBSS interference or detects nothing from the OBSS interference) in the first link, the second MLD also can perform the NPCA in the first link according to the NPCA indication from the first MLD. In addition, the STA 1 of the second MLD also can know when it needs to switch back to the primary channel of the first link according to the NPCA indication from the first MLD.

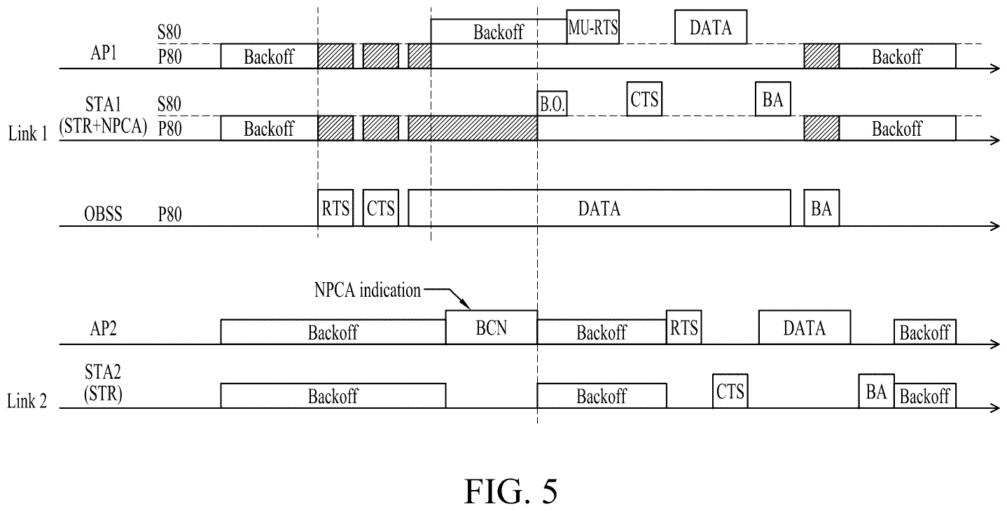

FIG. 5 is a schematic diagram illustrating a NPCA indication transmission according to another embodiment of the application. The NPCA indication transmission can be applied to the AP 110 and the communication apparatus 120 in the wireless communication system 100. In the embodiment, it is assumed that the first MLD is an AP MLD, and the second MLD is a non-AP MLD (e.g., an STA), but the invention should not be limited thereto. In addition, in the embodiment, the STA 1 and the STA 2 of the second MLD may be operated in the STR mode of the MLO. As shown in FIG. 5, the AP 1 of the first MLD may detect the OBSS interference in the primary channel (e.g., P80) of the first link (e.g., Link 1). Then, the first MLD may transmit the NPCA indication associated with the first link to the second MLD through the broadcast, multicast, control frames, management frame, or broadcast management frame (e.g., a beacon (BCN) frame) in the second link (e.g., Link 2). Therefore, when the AP 1 of the first MLD and the STA 1 of the second MLD need to perform the data transmission in the first link, both of the AP 1 and the STA 1 can switch to the non-primary channel (e.g., S80) of the first link according to the NPCA indication to perform the data transmission. That is, even if the second MLD does not detect the OBSS interference (e.g., the second MLD only detects the CCA from the OBSS interference or detects nothing from the OBSS interference) in the first link, the second MLD also can perform the NPCA in the first link according to the NPCA indication from the first MLD. In addition, the STA 1 of the second MLD also can know when it needs to switch back to the primary channel of the first link according to the NPCA indication from the first MLD.

It should be noted that the embodiments of the invention only use two links for illustration, but the invention should not be limited thereto. The first MLD also can provide the NPCA indications associated with more than one links to the second MLD.

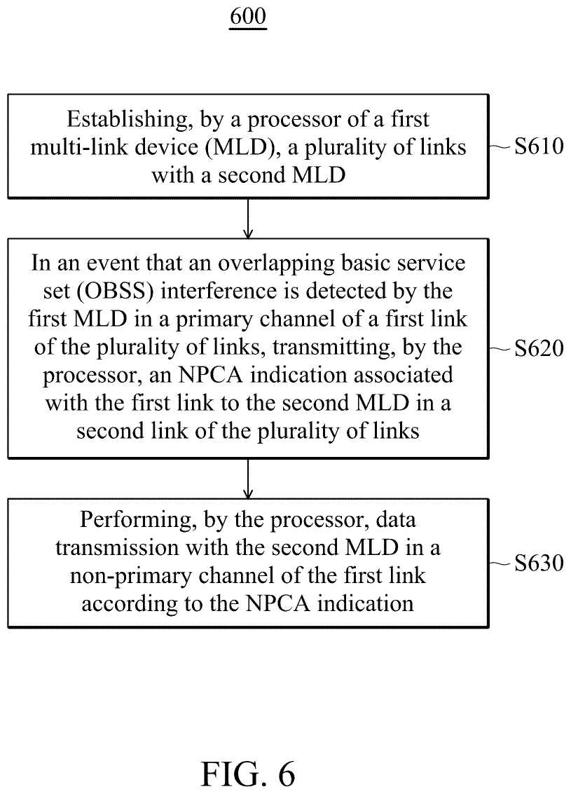

FIG. 6 is a flow chart illustrating an NPCA method 600 according to an embodiment of the invention. The data transmission method can be applied to an MLD apparatus (e.g., the AP 110 or the communication apparatus 120 in the wireless communication system 100). As shown in FIG. 6, in step S610, a first MLD may establish a plurality of links with a second MLD.

In step S620, in an event that an OBSS interference is detected by the first MLD in a primary channel of a first link of the plurality of links, the first MLD may transmit an NPCA indication associated with the first link to the second MLD in a second link of the plurality of links.

In step S630, the first MLD may perform data transmission with the second MLD in a non-primary channel of the first link according to the NPCA indication.

According to an embodiment of the invention, in the NPCA indication transmission method, the NPCA indication may comprise at least one of an index of the non-primary channel, a switch back time, a number of spatial streams (NSS), a bandwidth (BW), a modulation and coding scheme (MCS), and a transmission (TX) power.

According to an embodiment of the invention, in the NPCA indication transmission method, the switch back time may be associated with a countdown timer for the remaining duration of backing to the primary channel, or associated with a timestamp of an end time of the OBSS interference.

According to an embodiment of the invention, in the NPCA indication transmission method, the NPCA indication may be carried on a frame exchange sequence (FES), or on a FES with the second MLD.

According to an embodiment of the invention, in the NPCA indication transmission method, the NPCA indication may be transmitted through a broadcast, a multicast, a control frame, a management frame, or a broadcast management frame.

According to an embodiment of the invention, in the NPCA indication transmission method, the broadcast management frame may comprise a beacon frame.

According to an embodiment of the invention, in the NPCA indication transmission method, the first MLD may be an AP MLD and the second MLD may be a non-AP MLD, or the first MLD may be a non-AP MLD and the second MLD may be an AP MLD.

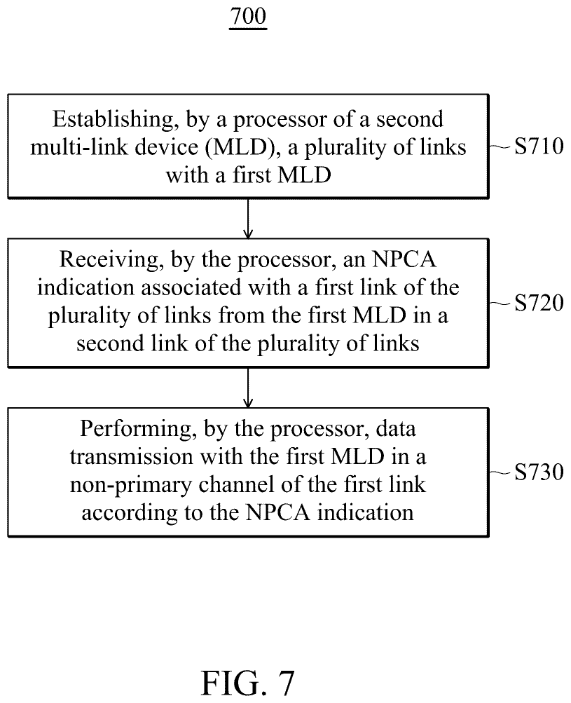

FIG. 7 is a flow chart illustrating an NPCA indication transmission method 700 according to another embodiment of the invention. The data transmission method can be applied to an apparatus (e.g., the AP 110 or the communication apparatus 120 in the wireless communication system 100). As shown in FIG. 7, in step S710, a second MLD may establish a plurality of links with a first MLD.

In step S720, the second MLD may receive an NPCA indication associated with a first link of the plurality of links from the first MLD in a second link of the plurality of links.

In step S730, the second MLD may perform data transmission with the first MLD in a non-primary channel of the first link according to the NPCA indication.

According to an embodiment of the invention, in the NPCA indication transmission method, the NPCA indication comprises at least one of an index of the non-primary channel, a switch back time, an NSS, a BW, an MCS, and a TX power.

According to an embodiment of the invention, in the NPCA indication transmission method, the switch back time may be associated with a countdown timer for a remaining duration of backing to the primary channel, or associated with a timestamp of an end time of the OBSS interference.

According to an embodiment of the invention, in the NPCA indication transmission method, the NPCA indication may be carried on a frame exchange sequence (FES), or on a FES with the second MLD.

According to an embodiment of the invention, in the NPCA indication transmission method, the NPCA indication may be received through a broadcast, a multicast, a control frame, a management frame, or a broadcast management frame.

According to an embodiment of the invention, in the NPCA indication transmission method, the broadcast management frame may comprise a beacon frame.

According to an embodiment of the invention, in the NPCA indication transmission method, the first MLD may be an AP MLD and the second MLD may be a non-AP MLD, or the first MLD may be a non-AP MLD and the second MLD may be an AP MLD.

According to the NPCA indication transmission method provided in the embodiments of the invention, the hidden node problem for NPCA can be avoided.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A non-primary channel access (NPCA) indication transmission method, comprising:
establishing, by a first multi-link device (MLD), a plurality of links with a second MLD;
in an event that an overlapping basic service set (OBSS) interference is detected by the first MLD in a primary channel of a first link of the plurality of links, transmitting, by the first MLD, an NPCA indication associated with the first link to the second MLD in a second link of the plurality of links; and
performing, by the first MLD, data transmission with the second MLD in a non-primary channel of the first link according to the NPCA indication.

2. The NPCA indication transmission method of claim 1, wherein the NPCA indication comprises at least one of an index of the non-primary channel, a switch back time, a number of spatial streams (NSS), a bandwidth (BW), a modulation and coding scheme (MCS), and a transmission (TX) power.

3. The NCPA indication method of claim 2, wherein the switch back time is associated with a countdown timer for a remaining duration of backing to the primary channel, or associated with a timestamp of an end time of the OBSS interference.

4. The NCPA indication method of claim 1, wherein the NPCA indication is carried on a frame exchange sequence (FES), or on a FES with the second MLD.

5. The NCPA indication method of claim 1, wherein the NPCA indication is transmitted through a broadcast, a multicast, a control frame, a management frame, or a broadcast management frame.

6. The NCPA indication method of claim 5, wherein the broadcast management frame comprises a beacon frame.

7. The NCPA indication method of claim 1, wherein the first MLD is an access point (AP) MLD and the second MLD is a non-AP MLD, or the first MLD is a non-AP MLD and the second MLD is an AP MLD.

8. An apparatus, comprising:
a transceiver which, during operation, wirelessly communicates with a transmitting apparatus through a multi-link device (MLD); and
a processor communicatively coupled to the transceiver such that, during operation, the processor performs operations comprising:
establishing a plurality of links with the MLD;
in an event that an overlapping basic service set (OBSS) interference is detected by apparatus in a primary channel of a first link of the plurality of links, transmitting, via the transceiver, an NPCA indication associated with the first link to the MLD in a second link of the plurality of links; and
performing data transmission with the MLD in a non-primary channel of the first link according to the NPCA indication.

9. The apparatus of claim 8, wherein the NPCA indication comprises at least one of an index of the non-primary channel, a switch back time, a number of spatial streams (NSS), a bandwidth (BW), a modulation and coding scheme (MCS), and a transmission (TX) power.

10. The apparatus of claim 9, wherein the switch back time is associated with a countdown timer for a remaining duration of backing to the primary channel, or associated with a timestamp of an end time of the OBSS interference.

11. The apparatus of claim 8, wherein the NPCA indication is carried on a frame exchange sequence (FES), or on a FES with the second MLD.

12. The apparatus of claim 8, wherein the NPCA indication is transmitted through a broadcast, a multicast, a control frame, a management frame, or a broadcast management frame.

13. The apparatus of claim 12, wherein the broadcast management frame comprises a beacon frame.

14. The apparatus of claim 8, wherein the apparatus is an access point (AP) MLD and the MLD is a non-AP MLD, or the apparatus is a non-AP MLD and the MLD is an AP MLD.

15. A non-primary channel access (NPCA) indication transmission method, comprising:
establishing, by a second multi-link device (MLD), a plurality of links with a first MLD;
receiving, by the second MLD, an NPCA indication associated with a first link of the plurality of links from the first MLD in a second link of the plurality of links; and
performing, by the second MLD, data transmission with the first MLD in a non-primary channel of the first link according to the NPCA indication.

16. The NPCA indication transmission method of claim 15, wherein the NPCA indication comprises at least one of an index of the non-primary channel, a switch back time, a number of spatial streams (NSS), a bandwidth (BW), a modulation and coding scheme (MCS), and a transmission (TX) power.

17. The NCPA indication method of claim 16, wherein the switch back time is associated with a countdown timer for a remaining duration for backing to the primary channel, or associated with a timestamp of an end time of the OBSS interference.

18. The NCPA indication method of claim 15, wherein the NPCA indication is carried on a frame exchange sequence (FES), or on a FES with the second MLD.

19. The NCPA indication method of claim 15, wherein the NPCA indication is received through a broadcast, a multicast, a control frame, a management frame, or a broadcast management frame.

20. The NCPA indication method of claim 19, wherein the broadcast management frame comprises a beacon frame.
